(19) United States
(12) Patent Application Publication
(10) Pub. No.: US 2006/0277835 A1
(43) Pub. Date: Dec. 14, 2006

(54) Floor mounted automobile protection system

(76) Inventor: James J. Duffy, Winfield, IL (US)

Correspondence Address: PYLE & PIONTEK, 221 N. LASALLE STREET,, SUITE 2036, CHICAGO, IL, 60601, US

(21) Appl. No.: 11/439,774

(22) Filed: May 24, 2006

Related U.S. Application Data
(60) Provisional application No. 60/684,734, filed on May 26, 2005.

(51) Int. Cl. G09F 7/18

(52) U.S. Cl. 52/39

(57) ABSTRACT

The floor mounted automobile protection system for a multiple car parking garage, lots or spaces comprises a cushion positioned between adjacent parking spaces of the garage or parking lot, which cushion is supported from the floor and sized to extend at least along a portion of the length of doors of cars parked in the spaces to keep the door of one car from striking the adjacent car when opened. Further, the cushion is flexible and supported from the floor in a flexible manner so as not to interfere with the exit and entry through the vehicle doors. Being floor or ground supported the present invention is useful in open or outside parking lots without any ceiling.

This non-provisional United States Patent application claims the benefit of and the priority of Provisional U.S. Patent application Ser. No. 60/684,734, filed May 26, 2005 of the same title as above, which is incorporated herein by reference.

### BACKGROUND OF THE INVENTION

The present invention relates to an automobile protection system. More particularly, the present invention relates to a floor supported cushion, which is used in a multicar garage or parking spaces in a manner to be positioned between adjacent vehicles in a multicar garage or parking spaces. The cushion is supported from the floor such that opening of a door of one vehicle does not come into contact with the side of the adjacent vehicle, but rather with the floor supported cushion, protecting the door and side of the either vehicle from damage when the door of the one vehicle is opened.

### PRIOR ART

Various embodiments of floor supported protectors have been proposed. However, none have been as versatile as that of the present invention which accommodates not only protection of automobiles, but also accommodates the opening of the closely spaced, parked automobile doors.

### SUMMARY OF THE INVENTION

According to the present invention there is provided a floor mounted automobile (car or vehicle) protection system for a multiple car garage or parking spaces having at least a floor. The invention is particularly advantageous in outside or open parking lots without any support structure above. The system includes a support structure or mounting bracket extending upwardly from the floor. The support structure is generally placed midway between adjacent car parking spaces and extends a substantial distance along and parallel to the parking space, say about 72 inches or 20% of the length of the space, or 30% of the length of the vehicle to be parked in the space, or at least 70% of the length of the doors on a typical 4-door vehicle, say from 60 inches to 96 inches. The support structure is located to permit exit from and entry into either vehicle located on either side of the system. A cushion, similar to that described in my U.S. Pat. No. 6,813,863, which is herein incorporated fully by reference, extends above the floor and downwardly from the top end of the floor mounted support structure, the cushion being preferably sized to extend along the length of the doors of cars parked in the parking spaces, and/or for the percentages or distances mentioned above. The support structure cushion is of a height sufficient to not interfere with a person entering a parked car, with the top of the cushion, say of from 2.5 feet to 4 feet, and preferably about 3 feet to 3.5 feet above the ground, while the bottom of the cushion 3 to 15 inches and, preferably, about 4 to 12 inches above the ground to keep it clear of the users' feet. The cushion is very flexible from side to side to accommodate and be moved by opening of a door of either one of the adjacent parked cars, with the cushion rather than the opening door striking the adjacent parked car. Thus, two or more cars may be parked in adjacent parking spaces without the opening door of one car contacting or denting the other car or being interfered with by the floor mounting system.

The present invention enjoys a particular advantage in parking lots that are open and have no ceiling or other upper structure to support such a cushion, even over that shown in my U.S. Pat. No. 6,813,863.

### DESCRIPTION OF THE DRAWINGS

FIG. 1 is a front elevational view of one form of floor support structure having a flexible rod mounted on one style of a spring attached to a floor mounted base for use between two cars, and illustrates in dotted lines how the support can bend or flex.

FIG. 1A is perspective view of a second embodiment of floor support generally similar to that shown in FIG. 1, but having a second style spring.

FIG. 2 is a perspective view of one embodiment of a cushion used in the automobile protection system of the present invention.

FIG. 3 is an assembly of several supports of FIG. 1A (or alternately could be of FIG. 1) and the cushion of FIG. 2 shown mounted between the parking spaces or on the garage floor.

FIG. 4 is a front elevational view showing the automobile protection system installed between two automobiles in a garage.

FIG. 5 is a top view and shows the protection system of the present invention installed between the two vehicles, with the garage details other than the floor deleted for clarity.

FIG. 6 is a perspective view of the automobile protection system shown protecting the adjacent vehicles in the parking spaces.

FIG. 7 is a top view similar to FIG. 5, but showing how the opening of the door of one vehicle deflects the cushion of the present invention to permit entry/exit while protecting the adjacent vehicle.

FIG. 8 is a front elevational view of the parking alignment system described in my U.S. Pat. No. 6,813,863, also used in conjunction with the floor mounted protection system of the present invention showing an automobile in dashed lines.

FIG. 9 is a top view of the parking alignment system and floor mounted protection system.

FIG. 10 is a side elevational view of one of the automobiles shown in FIGS. 9 and 10.

FIG. 11 shows the positioning elements of FIGS. 9 and 10 as seen by a driver through the windshield.

FIG. 12 is a top plan view similar to FIG. 7, but showing the cushion flexing in an opposite direction upon opening of a door of a second car adjacent the cushion.

FIG. 13 is a perspective view showing a front door of one vehicle on one side of the cushion and a rear door of an adjacent vehicle on the other side of the cushion opened simultaneously with the cushion flexing to accommodate both.

FIG. 14 is a cross-sectional view of an alternative floor support having one style spring.

FIG. 15 is a view similar to FIG. 14 but showing that floor support with a second style spring.

FIG. 16 is a view from the bottom showing the ribbing of supports of FIG. 14 or 15 taken on the line 16-16 of FIG. 15.

FIG. 17 is a third style base for use with the present invention having two reflectors.

FIG. 18 is an exploded, cross-sectional view of the base of FIG. 17 turned 90° showing how the floor support may be assembled.

FIG. 19 is a cross-sectional assembled view showing a base as in FIGS. 17 and 18, but with another style spring.

### DESCRIPTION OF PREFERRED EMBODIMENT

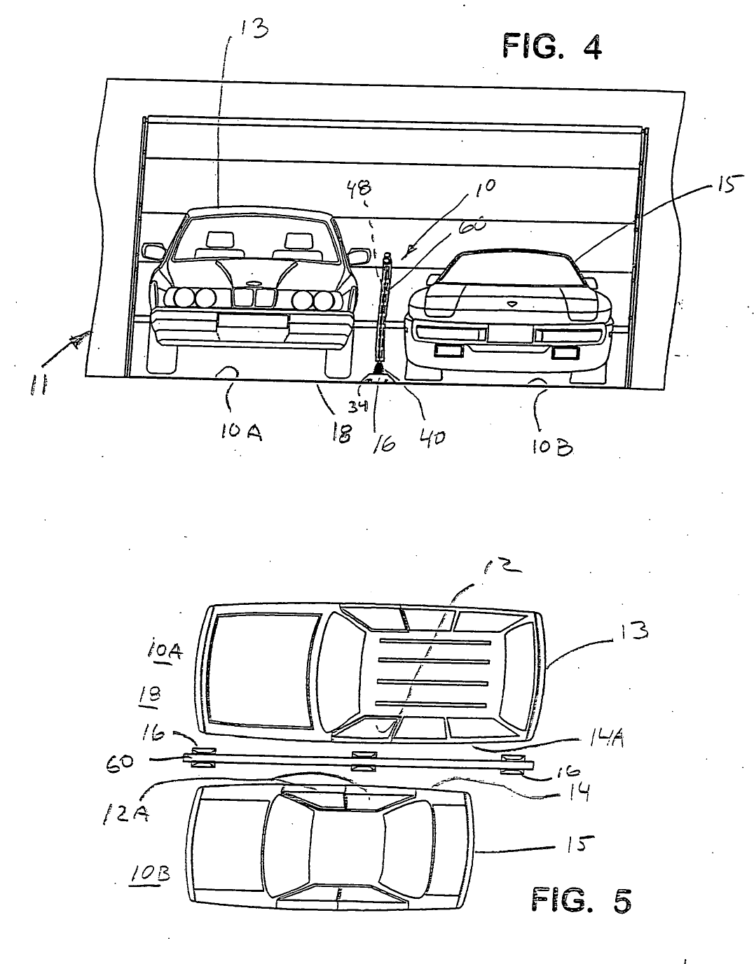

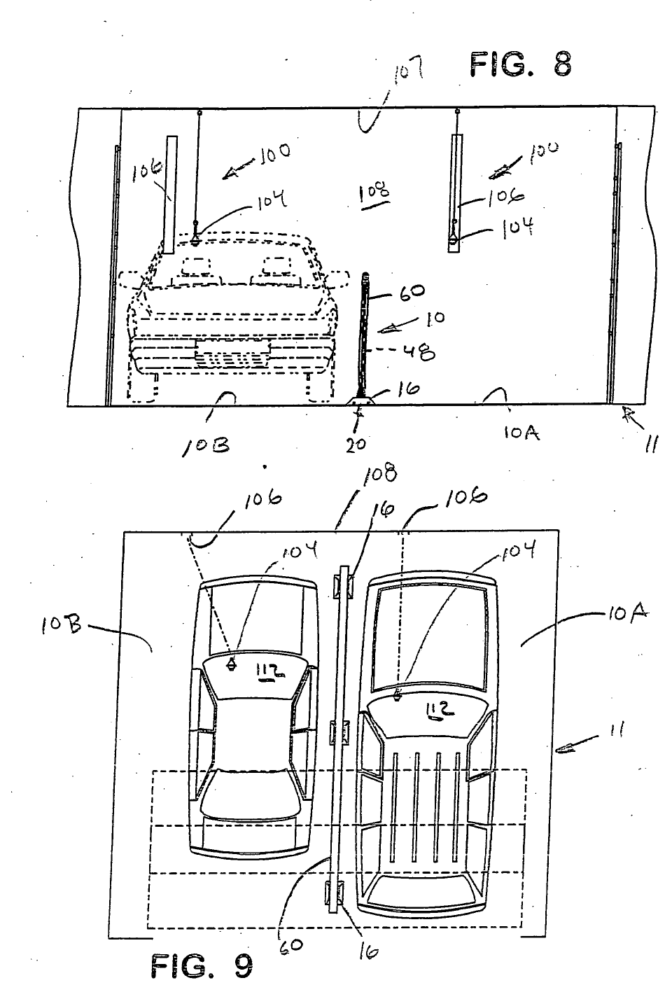

Referring now to the drawings in greater detail, there is illustrated in FIG. 3-9 therein a floor mounted automobile protection system of the present invention generally identified by the reference numeral 10 for use with adjacent parking spaces 10A and 10B (for example see FIGS. 4 and 5), such as in multicar garage 11 or a parking lot to keep doors 12 of a first vehicle 13, upon opening, from contacting the side 14 of the adjacent vehicle 15, and causing dents, chips, or other damage, etc., therein, which commonly takes place when an open door 12 of a vehicle 13 contacts an adjacent vehicle 15. Of course, the present invention also protects the opening of doors 12A of the adjacent vehicle 15 from damaging the side 14A of the first vehicle 13.

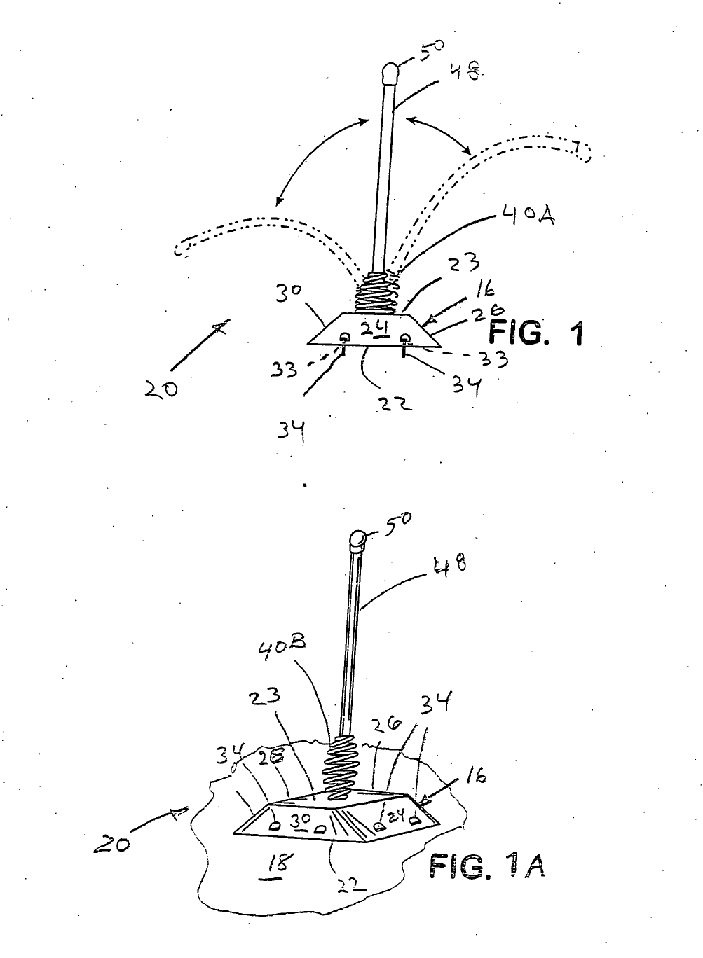

In FIGS. 1, 1A, and 3, the floor support structure 20 of the system 10 is better illustrated and shows the same to incorporate a support base or mounting member 16 which is engageable to the floor 18 of the garage 11 or other parking structure providing parking spaces 10A and 10B.

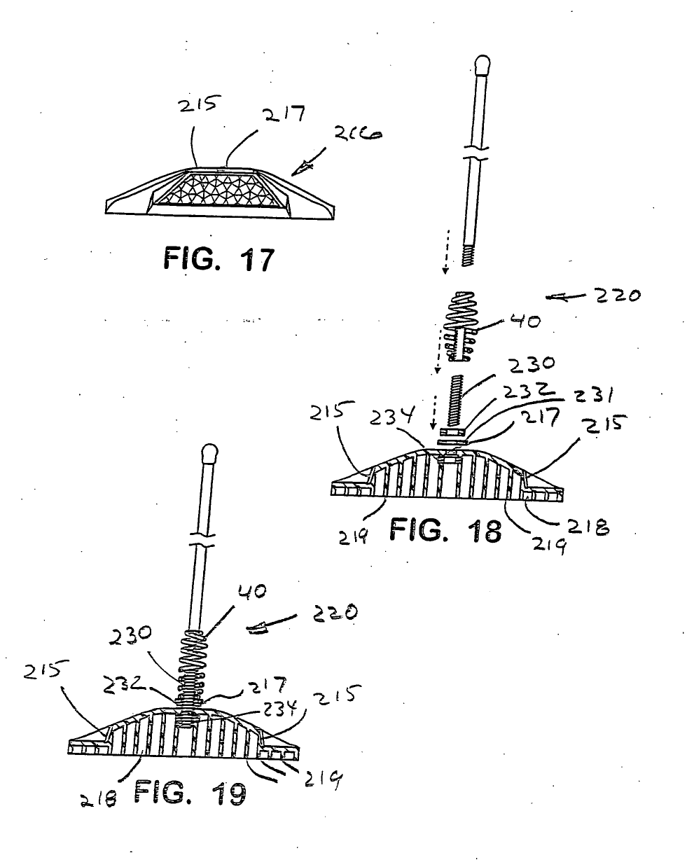

As is shown in FIGS. 1 and 1A, the mounting support 20 base 16 is adapted to be secured to the floor, such as by adhesive or a plurality, in this instance eight, fasteners 34. In this instance, the support base 16 generally has a square or rectangular bottom 22 (which could be suitable to receive or cooperate with adhesive—see FIGS. 16, 18 or 19), top 23 and four sloped sides 24, 26, 28 and 30. Preferably reflective or iridescent surfaces could be provided on the visible or extended portions of the support 20, and preferably the base 16 (see FIGS. 17-19), to help make it visible in no or low light, such as at night and or when the garage door is closed and no lights, either the vehicle's or garage's, are on. For convenience, the base 16 can be provided with openings 33 to receive a plurality of fasteners 34, such as screws, bolts, etc., to hold the support base 16 to the floor, with or without the use of adhesive. Of course, it should be understood that an adhesive, such as epoxy, cements and glues, could also be used alone.

Preferably mounted to the support 16 is a flexible spring 40 such as a conical style spring 40A shown in FIG. 1 or the double conical style spring 40B shown in FIG. 1A. The springs could measure from ⅞ inch diameter to 3 inches in outside diameter, from 3 inches to 8 inches in height, and from 1/16 inch to ¼ inch in spring coil wire diameter. The inside diameter at the top of the spring is such to accommodate a rod. At the bottom the spring inside diameter is such to engage the spring mounting bolt or stud.

As is shown in FIGS. 1 and 1A, on the spring 40 (40A or 40B), a further flexible rod 48 is provided. One end of the rod is secured, say as by being inserted or threaded into the center of the coil spring 40A or 40B and the other end is rounded, and or provided with a round protective cap 50. It should be understood that the ends of the springs may include female threaded end disks to which the respective ends the spring is attached. The rod 48 could be made, for example, of carbon fiber, fiberglass, spring steel, etc.

As is shown in FIG. 1, and would also be true of FIG. 1A embodiment, the rod and spring can both flex. Preferably, with the support 20 secured to the floor, its upper structure both in this instance spring 40A and rod 48, will bend to about 90 degrees with a force from 3 pounds to 12 pounds. Again, preferably this flexibility is exhibited at least side to side, and to some degree in all directions. This flexure helps accommodate the motions caused by the opening of the various car doors in the adjacent spaces. While the rod 48 shown is of a round or circular in cross section, it could be of another shape, such as square, rectangular, elliptical, etc. Typically the rod 48 would be about 30 inches to 50 inches long with about 38±2 inches being ideal and cross sectional of 1/16 to ¼ inches square and spaced apart from 2 feet to 8 feet, with about 36 inches being ideal. For example, a rod of ⅛ inches to ⅝ inches in diameter is a good size. Also, if the rod is of sufficient flexibility itself, the spring might be omitted, and the rod directly mounted to the support base, or even directly into openings, such as a hole or opening made, drilled or otherwise provided in the floor itself.

Carried on the plurality (at least two, and preferably three or more) flexible supports 20 is a cushion 60 which is elevated and oriented and held at a position between the vehicle body sides 14 or 14A of the adjacent vehicles 13 and 15 such that the opening of door 12 or 12A of either takes place against the cushion 60 rather than the body side of the adjacent vehicle 13 or 15. The supports 20 are placed to permit the cushion 60 to extend well along the sides of the parked vehicles as is discussed above, but to not interfere in the ingress or egress.

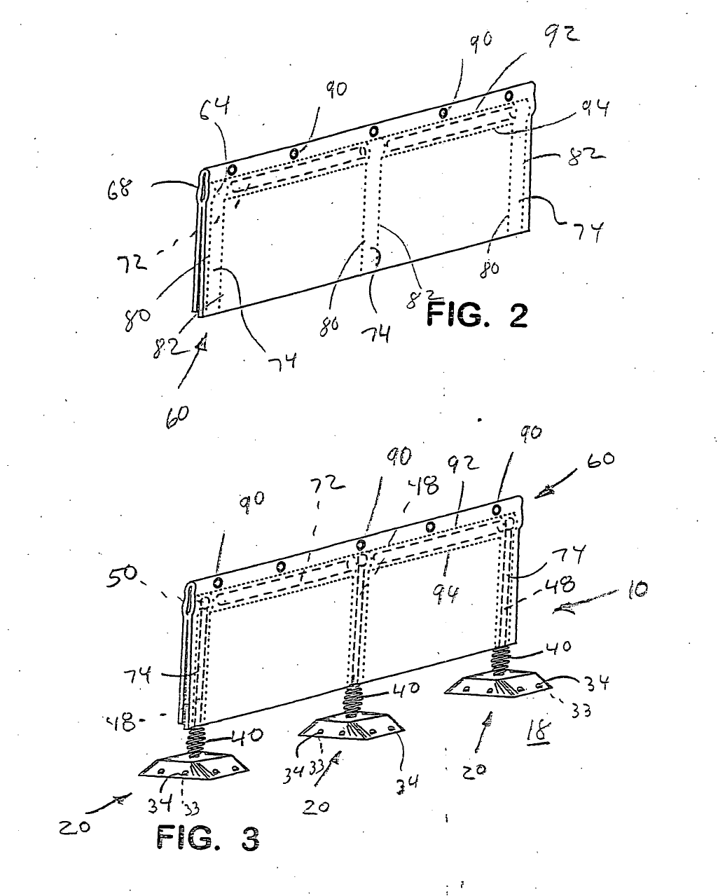

Turning to FIGS. 2 and 3, it will be seen that the system 10 is created from multiple parts. The cushion 60, itself preferably, is double folded material along an upper line or periphery 64 thereof and has, preferably a horizontal cloth or material pocket 68 created adjacent the folded upper periphery 64 within which a firm yet flat, flexible element, bar, strip, or rod 72 may be received. It should be understood that this flexible element is optional and not always necessary. This strip could be made of steel, plastic or composite materials such as carbon fiber. The flexible rod or strip 72 should have vertical stiffness to help prevent sag of the cushion, but yet must permit the rod and cushion to flex horizontally to absorb door movement. Preferably, the rod's cross section is generally many times higher (vertically) than it is thick (horizontal) to give it the desired directional flexibility and vertical support. For example, the cross section could be 1 inch high and 0.04 inches thick.

As shown in FIGS. 2 and 3, the cushion 60 has several vertical pockets 74, one for each support 20, formed therein, say by sewing or stitching 80 and 82 the double folded material together to form the two or more, and preferably three, vertical pockets 74, which are open at the bottom. The pockets should be spaced about 3 feet to 5 feet apart with about 3.5 feet to 4 feet being preferred.

As shown in FIG. 3, the cushion with its pockets 74 are slipped onto a set of properly correspondingly spaced supports 20 and their rods 48. It should be noted that in doing so, the cushion 60 and its pockets 74 will also automatically properly space the supports for installation purposes. The supports' positions can then be marked on and then fastened to the floor.

For reasons of economy of manufacture, the cushion used with the present invention could be made also to accommodate the invention in my U.S. Pat. No. 6,813,863. To this extent, the cushion 60 could also be adopted to receive and be suspended as shown therein, and have the cushion structure called for therein, such as the hanging grommets 90. Also, it will be seen therein, that the hangers depend from the clips that are engageable to the cushion via openings or grommets 90 created in the upper periphery above the horizontal pocket. Of course, other means than the clips and openings could be used.

Also, as shown in FIGS. 2 and 3, the double thickness of the cushion 60 may be sewn, as at 92 and 94 to form the horizontal pocket 68.

FIGS. 3-6 show the garage floor support structures 20 to which the system 10 can be engaged. Also, as noted earlier, the two supports or more need not be placed similarly, but each could be placed as needed or desired, which is about 36 inches apart for best flex and support. Of course the cushion 60 would need to be constructed to accommodate the desired support spacing. It should be noted that one of the supports is near or at the rear of the garage, while the other is toward the front of the garage. Preferably, a third support is used in between. With two supports, the support members are spaced apart about or at least 20% the length of the automobile to be parked therein. The support member closest to the garage door, if present, is spaced a few (six) feet, or less behind the open garage door, the other or second support member being at least 6 feet behind the first support member if only two are employed. A third support member may extend from the floor, about in the center between the two front and rear supports.

FIG. 7 shows flexibility of the cushion 60 as the door 12 of a car 13 is opened there against.

FIGS. 8-11 show the provision of a positioning apparatus 100 in the form of spaced indicia, for positioning the cars 13 and 15 appropriately relative to the system 10 and in spaced 10A and B. This positioning system is like that shown in my U.S. Pat. No. 6,813,863. Such positioning apparatus is defined in greater detail in the description of the method of use below. It will be understood, that the positioning apparatus is not only used to make sure the car 13 and 15 are pulled far enough forward into the garage 11, but also to allow sufficient distance between the cushion 60 and the car door(s) 12 and 12A to allow one to enter either car 13 or 15 via the door(s) 12 or 12A adjacent the cushion 60.

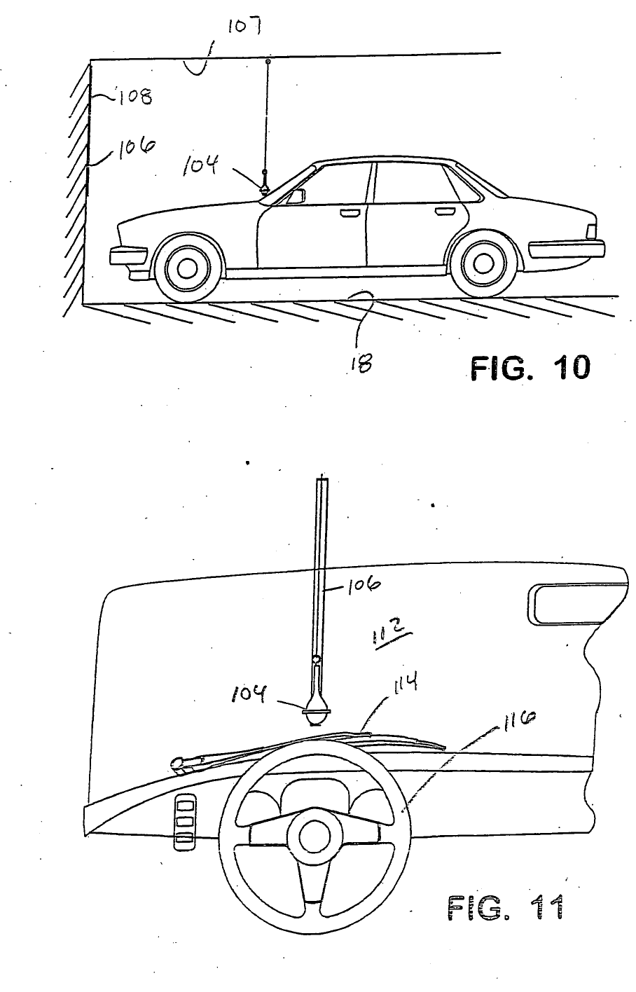

FIGS. 10 and 11 show desired front to back alignment of the car 13 using one windshield engaging element 104 of the positioning apparatus 100 with FIG. 11, showing the driver's view of the alignment of the windshield engaging element 104 in centered position relative to cooperating indicia or strip 106 on the rear garage wall 108.

FIGS. 4-9 and 12-13 show that when the cars 13 and 15 are appropriately positioned using the positioning apparatus 100 (not shown in FIG. 3 but shown in FIGS. 8-11), entry and egress through the doors 12 adjacent the cushion 60 and its floor supports 20 are easily accommodated.

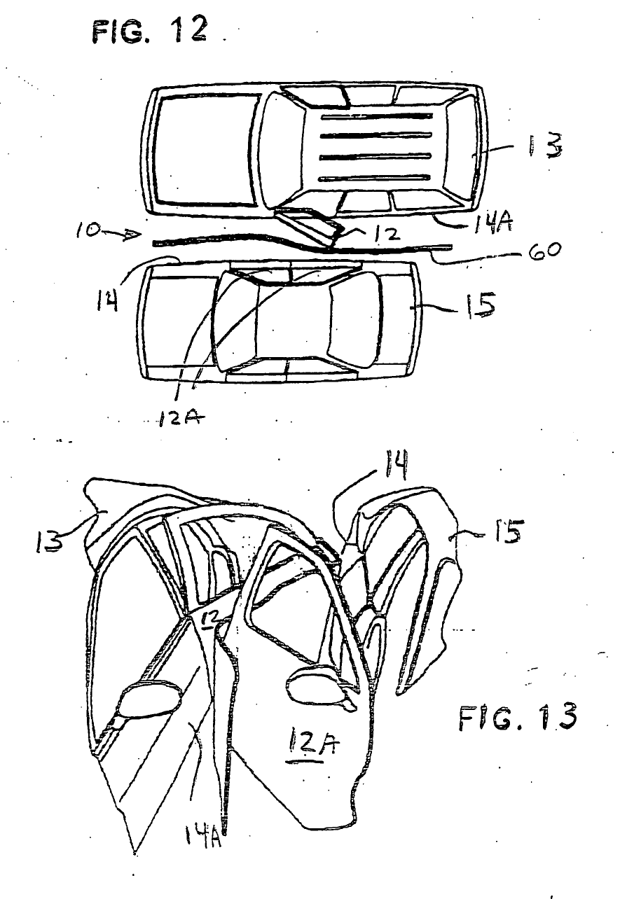

FIGS. 12 and 13 show that the cushion 60 can flex in two directions and simultaneously in adjacent areas when doors 12 and 12A of both cars 13 and 15 adjacent thereto are opened simultaneously.

The method of installation is as follows:

Park one of the vehicles 13 or 15 in desired locations with in the garage 11 or parking spaces 10A and B.

Engage windshield engaging positioning member 104 (forming one of the spaced indicia) to the ceiling 107 with that member touching the windshield 112 just above the windshield wiper 114 and centered over the steering wheel 116. The member 104 can be, for example, a ball hanging from a string or the like attached to the roof, ceiling or support beam of the garage or parking structure.

Align the reflective strip or adhesive tape 106 (forming the other of the spaced indicia) on the wall 108 in front of the vehicle 13 or 15, so when the driver is looking through the windshield 112, the member 104 is centered on the reflective strip 106. Back the one vehicle 13 or 15 out of the garage 11 and then drive it in using the positioning apparatus 102. When the windshield 112 strikes the member 104 and it is centered on the reflective strip 106 the car 13 or 15 should be properly parked.

With the one vehicle 13 or 15 located, the above procedure is used to locate the other vehicle 13 or 15 to be adjacently parked in the adjacent space. This adjacent vehicle has its own or second set of locating elements 104 and 106.

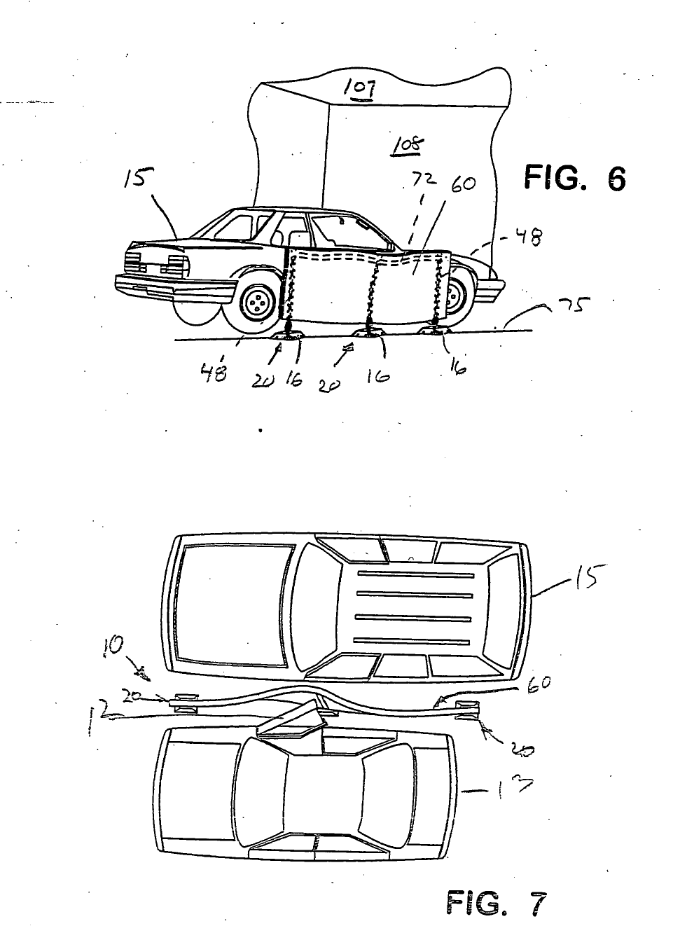

With the two vehicles located, the distance between them is measured. Preferably this distance is from 12 inches to 36 inches and preferably 24 inches. The measured distance then is divided by two and points are marked to form a centerline 75 (FIG. 6) for the cushion supports 20. The cushion 60 and the vertical pockets 74 therein are used to determine how far apart the supports should be on the center line 75. In fact, the supports 20 can be placed in the vertical pockets 74 and then the cushion 60 will self locate the supports 20. The cushion 60 is then located relative to the vehicles length and parking spaces. All the consumer need do is determine, where relative to the vehicle doors, the cushion 60 should be placed. The cushion supports 20 may then be mounted to the floor as with adhesive, fastening or both. The necessary appropriate openings are made or drilled in the floor (if needed or used) to secure the fastener used, be it concrete bolt, screws and/or adhesive, synthetic cements or epoxies and tape.

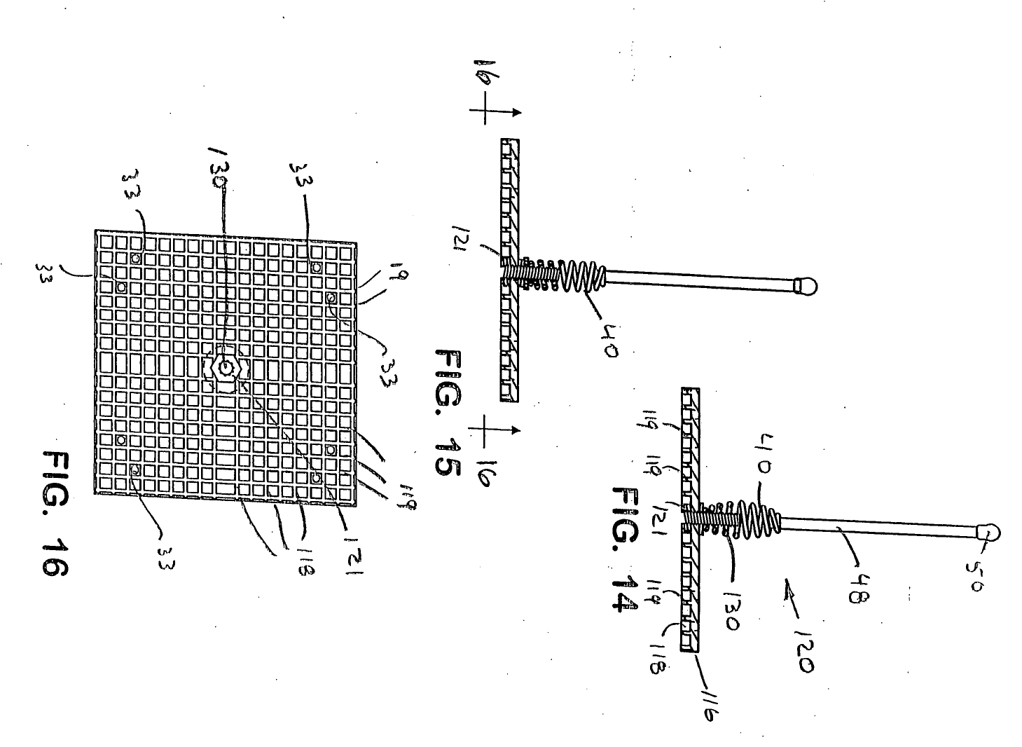

Referring to FIGS. 14-16, an alternative support 120 is shown and has a flat base 116 with a honeycomb of intersecting right angled ribs 118 and 119 to help hold the base to the floor with adhesive. As shown in FIGS. 14 and 15 again various spring styles can be used. Preferably as noted above the ends of the springs carry threaded disk to receive both the rod 48 and retaining stud or bolt 130. The base 116 has an opening 117 to accommodate the bolt or stud 130. The base accommodates a nut 121 in the bottom (or head of the bolt). Both are held against rotation by epoxy and/or the adhesive used to hold the base to the floor. The advantage of the stud over the headed bolt is: with the rod, spring, and stud removed only the flat base remains on the floor, to minimize interference with the user. If the bolt or screw is used, with the rod and spring removed, the bolt or screw would still extend above the base.

Referring to FIGS. 17 to 19, another preferred base 216 and support 220 is shown. The base 216 is a modified highway or road marker, such as offered by RoDon Corp. and model type “Blue Synthetic”. The base 216 has two reflective surfaces 215 to help make it visible in low light, the honeycomb, ribbed bottom 218, 219 for increased grip with adhesive, and a center opening 217 for a headed screw or bolt or, preferably, a stud 230. As shown in FIGS. 18 and 19 the stud 230 is held onto the base by upper (optional) and lower nuts 232 and 234. If desired a washer 231 (only one shown) could be provided for each nut. The lower nut 234 in turn will be held against rotation and in place relative to the base by epoxy and/or the adhesive. The stud is screwed onto this secured lower nut 234. The stud is held in place by the upper nut 232 and/or threaded into lower end of the spring. The spring is them installed with the rod 48 threaded or connected to the upper end of the spring, and if desired the cap 50 may be put onto the upper end of the rod, and/or that end of the rod rounded for protection and to prevent excessive wear on the top of the cushion pocket.

It should be understood in a multicar parking garage or lot (say an open lot), the system of the present invention could be provided on each side of each parking space, be it two or 200.

As described above, the floor mounted automobile protection system of the present invention provides a number of advantages, some of which have been described above and others of which are inherent in the invention. Also, modifications including equivalent elements and/or steps can be proposed to the floor mounted automobile protection system without departing from the teachings herein.

What is claimed is:

1. A floor mounted automobile protection system for a multiple vehicle garage having a floor, comprising at least two support structures extending upward from the floor, said support structures being placed between the multiple vehicle parking spaces, said support structures being located to permit said vehicles' doors to open, a cushion extending downward from the tops of said support structures toward the floor, said cushion being sized to extend along the length of the doors of vehicles parked in the parking spaces, said support structures being located and of a height sufficient to not interfere with a person entering or exiting a parked vehicle, said supported structures and said cushion being flexible to accommodate and be moved by opening a door of either one of said parked vehicles, with said cushion and not said opening door striking the adjacent parked vehicle, whereby two or more vehicles may be parked in said parking spaces without the opening door of one vehicle contacting the other vehicle.

2. An automobile parking system as in claim 1, further comprising flexible means for supporting said cushion from said floor.

3. An automobile protection system as in claim 2, wherein said flexible means includes a flexible rod.

4. An automobile protection system as in claim 3, wherein said flexible means further includes a spring, said flexible rod being mounted on said spring.

5. An automobile protection system as in claim 1, wherein said flexible means includes a base, said base being mounted to the floor between the parking spaces.

6. An automobile protection system as in claim 5, further including a spring mounted to said base, said flexible rod being mounted to said spring, the flexible rod supporting said cushion.

7. An automobile parking system as in claim 1, wherein said vehicle garage has an opening and closing door for use by the vehicles, said support system includes at least two support members, said support members being spaced apart at least 30% the length of the vehicle to be parked therein, said support member closest to the garage door being spaced a few feet or less behind the closed garage door, the other support member being spaced behind the first support member, a third member extending between the first and second support members, whereby the support system can support a cushion and not interfere with the opening of the vehicle doors.

8. An automobile parking system as in claim 1, including indicia means for locating said vehicles in said parking spaces.

9. An automobile protection system as in claim 1, wherein said support structures are secured to said garage floor with fasteners.

10. An automobile protection system as in claim 9, wherein said support structure is screwed to said floor.

11. An automobile protection system as in claim 9, wherein said support structure is adhered to said floor.

12. An automobile protection system as in claim 11, wherein said support structure is epoxied to said floor.

13. An automobile protection system as in claim 9, wherein said support structure is also adhered to said floor.

14. An automobile protection system as in claim 5, wherein said base is formed from a highway marker.

15. A method for protecting the sides of adjacent parked automobiles, comprising locating the adjacent automobiles on the adjacent parking spaces, mounting bases to the parking space floor, mounting flexible generally vertical members to the bases, installing a cushion on said flexible generally vertical members.

16. A method as in claim 15, further including installing indicia adjacent the parking spaces to locate the vehicles in the parking spaces.

17. A method as in claim 15, comprising finding a centerline between said parking spaces and locating said bases on said centerline.

18. A method as in claim 17, comprising the step of screwing said bases to said floor on said centerline.

19. A method as in claim 17, comprising the step of adhering said bases to said floor on said centerline.

20. A method as in claim 15, comprising adapting highway marks to form said bases.
